(19) United States
(12) Patent Application Publication
(10) Pub. No.: US 2015/0204720 A1
(43) Pub. Date: Jul. 23, 2015

(54) SPECTROMETER AND METHOD OF USE

(71) Applicants: Yair Z. Lauber, Givat Shmuel (IL); Nitzan Chamiel, Jerusalem (IL); Natan S. Kopeika, Beer Sheva (IL); Ishaiahu M. Danziger, Jerusalem (IL)

(72) Inventors: Yair Z. Lauber, Givat Shmuel (IL); Nitzan Chamiel, Jerusalem (IL); Natan S. Kopeika, Beer Sheva (IL); Ishaiahu M. Danziger, Jerusalem (IL)

(73) Assignee: SCIENTIFIC-WIZARD LTD, Givat Shmuel (IL)

(21) Appl. No.: 14/367,238

(22) PCT Filed: Dec. 20, 2011
(86) PCT No.: PCT/IL2011/000954

§ 371 Date: Nov. 3, 2014

Related U.S. Application Data
(60) Provisional application No. 61/457,062, filed on Dec. 20, 2010.

(51) Int. Cl. G01J 3/14; G01J 3/28

(52) U.S. Cl. CPC G01J 3/14; G01J 3/2803; G01J 3/2823

(57) ABSTRACT

A method and system for linear spectral dispersion comprising passing an incoming electromagnetic signal through a compound prism consisting of two prisms in opposite orientation, where the two prisms are selected to provide a linearly varying output angle over a broad spectral region.

### BACKGROUND

Spectroscopy is the study of the interaction between matter and radiated energy. Historically, spectroscopy originated through the study of visible light dispersed according to its wavelength.

Newton is credited with using a prism to refractively disperse white light into the optical spectrum. More recently, reflective gratings have been used to disperse mixed light into separate wavelengths. Some transparent crystalline materials having appropriate long range repetitive order can be used to refractively disperse an incident polychromic electromagnetic signal into its spectrum.

Grating based spectrometers produce second and third order spectra that may overlap the primary order spectrum, leading to interference phenomena such as ghosting and cross-talk. Prisms do not produce such higher order spectra and are thus preferable to separate polychromatic light and/or other (non-visble) electromagnetic wavelengths into separate signals. However prisms do not disperse light linearly.

Consequently, coupling a prism to a light detector comprising a pixel array, such as a CCD or CMOS detector is complicated, and typically results in non constant wavelength resolution or variable signal to noise ratio. This has limited the practical application of prism based spectrometers and spectral imagers.

Due to the disadvantages of gratings and of prisms, there is a need for linear spectral dispersion via prisms, and the present invention addresses this need.

### SUMMARY OF THE INVENTION

A first aspect of the invention is directed to providing a method for linear spectral dispersion of an incoming polychromatic electromagnetic signal, comprising passing the incoming polychromatic electromagnetic signal through a compound prism comprising two prisms in opposite orientation, where the two prisms are selected to provide a linearly varying output angle over a broad spectral region.

Optionally a third prism is added to increase the linearity of the range.

Optionally a third prism is added to increase the range where dispersion is substantially linear.

Typically, Δp is large.

In one embodiment the compound prism comprises a BK7 or KDP prism with apex angle of 20° coupled to a SF11 prism with apex angle in the range of from 2.5° to 7°.

Optionally, the SF11 prism has an apex angle of 3.92°.

A second aspect of the invention is directed to providing a system for substantially linear spectral dispersion over a range, the system comprising a compound prism comprising at least two simple prisms in opposite orientation.

Optionally, the compound prism comprises a third prism to increase the range.

Optionally the system comprises a third prism to increase the linearity.

Typically, the system further comprises a detector of incident light.

Preferably, the detector is selected from the group comprising CMOS and CCD detectors.

Typically, the compound prism comprises a BK7 or KDP prism with apex angle of 20° coupled to a SF11 prism with apex angle in the range of from 2.5° to 7°.

Preferably, the SF11 prism has an apex angle of 3.92°.

A third aspect of the invention is directed to a spectral imager comprising a compound prism comprising a pair of oppositely arranged simple prisms and a light detector, wherein the oppositely arranged simple prisms are selected such that the compound prism has an output that varies substantially linearly over a range of wavelengths of interest.

Optionally, the spectral imager comprises a third prism to increase the linearity of the output.

Optionally the spectral imager comprises a third prism to increase the range.

Typically, the spectral imager further comprises a detector selected from the group comprising CMOS and CCD detectors.

In one embodiment, the compound prism comprises a BK7 or KDP prism with apex angle of 20° coupled to a SF11 prism with apex angle in the range of from 2.5° to 7°.

Preferably, the SF11 prism has an apex angle of 3.92°.

A fourth aspect of the invention is directed to providing a method of imaging a spectrum comprising providing a compound prism designed to produce a linearly varying output over a wide range of wavelengths and a light detector selected from the group comprising CMOS and CCD detectors such that an incoming signal is refracted by the compound prism into a substantially linear output that is detected by the light detector.

Optionally a third prism is provided in series with the compound prism or as part of the compound prism to increase the linearity or the range of the output.

In preferred embodiments, the compound prism comprises a BK7 or KDP prism with an apex angle of 20° coupled to a SF11 prism with apex angle in the range of from 2.5° to 7°.

Preferably, the SF11 prism has an apex angle of 3.92°.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice.

In the accompanying drawings:

FIG. 1 is an Optical transmission spectrum for BK7;

FIG. 2 is an optical transmission spectrum for SF11;

FIG. 3 is a Cartesian plot of dispersion angle (in Radians) with wavelength for a simple prism, illustrating that the dispersion of a prism is non-linear;

FIG. 4 is a schematic illustration of a compound prism, showing how light is refracted therein;

FIG. 5 is a Cartesian plot showing how different pairs of glass materials have different secondary angular dispersions;

FIG. 6 is a p vs v plot for different glasses, showing how different glasses can share common p values;

FIG. 7 shows the deviation angle with wavelength for a couplet consisting of a BK7 prism with a 20° apex angle, coupled with SF11 prisms having apex angles in the range of 2.63° to 6.5°, illustrating how a substantially linear dispersion may be obtained over an appropriate wavelength for an appropriate couplet;

FIG. 8 shows how a KDP prism with a 20° apex angle coupled to an SF11 prism with a 3.3° apex angle provides a substantially linear dispersion;

FIG. 9 shows the refraction indexes of SF11 and KPD as a function of λ.

### BRIEF DESCRIPTION OF PREFERED EMBODIMENTS

Embodiments of the present invention provides a linear dispersion of an incoming mixed wavelength electromagnetic signal such as polychromatic light, or white light, into its spectrum, without ghosting, thereby overcoming the disadvantages inherent in traditional prism systems and in gratings.

A linear dispersion without ghosting or cross-talk is obtained by using a compound prism comprising two prismatic elements having carefully chosen optical characteristics and shape aligned in opposite orientation. Practical systems will invariably include other optical elements for collimating and focusing the signal. Also, light detecting means, such as a CCD or CMOS array of pixels may be added.

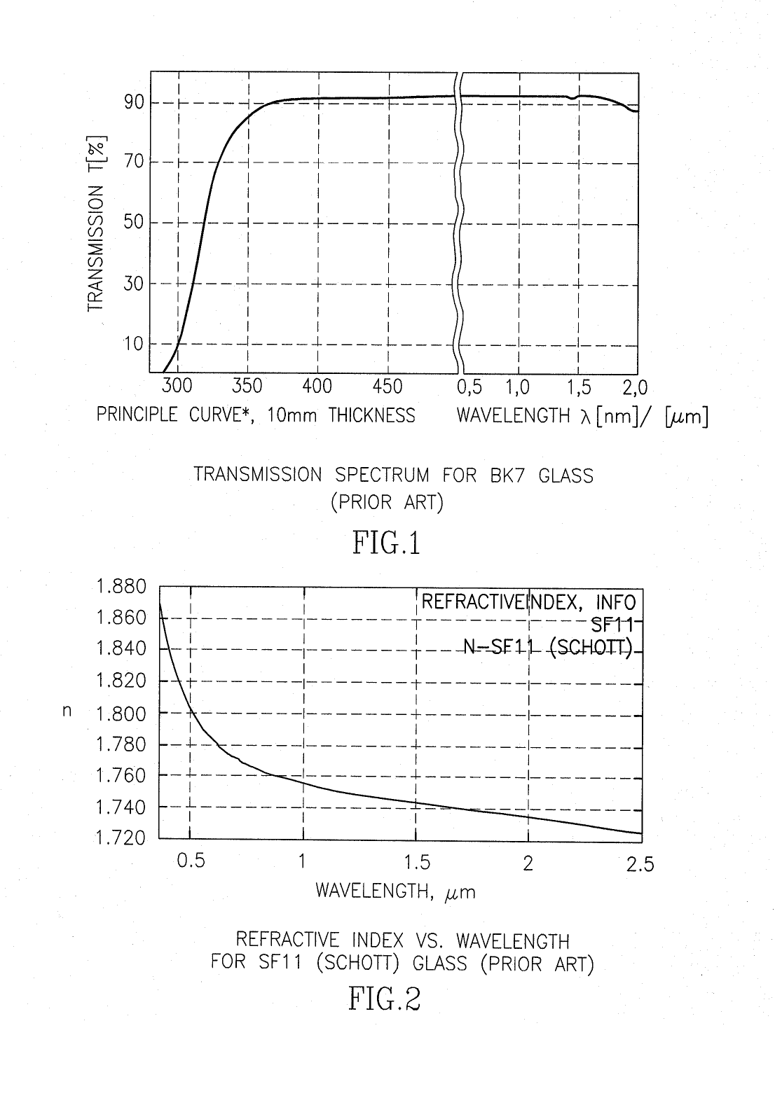

With reference to FIGS. 1 and 2, the optical properties of a couple of common optical glasses, BK7 and SF 11 are shown.

Optical glasses may be used to fabricate lenses, prisms and other simple optical components.

### Theory

### Dispersion in a Prism

The angular deviation of a thin prism may be approximated as

D=(N−1)·θ [1]

where n is the refractive index and θ is the apex angle of the prism.

The derivative of the angular deviation is the angular dispersion:

$$dD = D \frac{dn}{n - 1} \qquad [ 2 ]$$

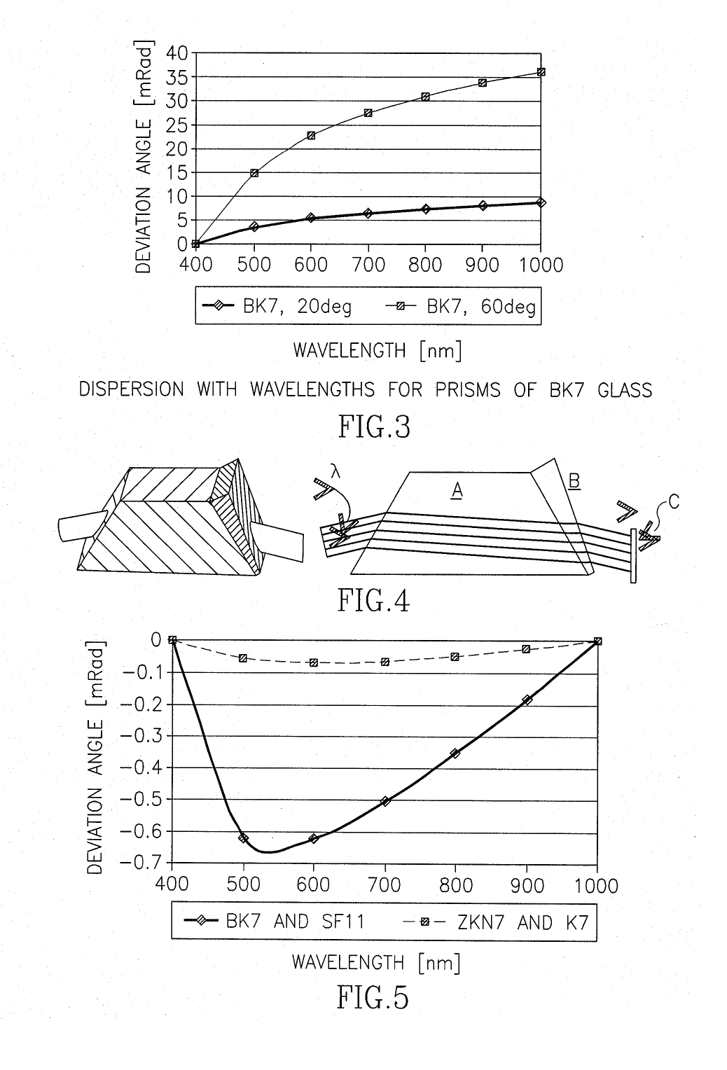

FIG. 3 shows the angular dispersion of a prism made of BK7 glass.

For a spectral region of interest defined in terms of λₘᵢₙ, λ_{mid} and λₘₐₓ, the refractive index at λi is labeled as n_{λi} and dispersion may be defined as:

dn=n_{λmax}−n_{λmin} [3]

The Abbe number is defined as

$$ν = \frac{{n}_{λ mid} - 1}{{n}_{λ max} - {n}_{λ min}} = \frac{{n}_{λ mid} - 1}{dn} \qquad [ 4 ]$$

This enables a simpler expression for the angular dispersion to be derived:

$$dD = \frac{D}{v} \qquad [ 5 ]$$

With reference to FIG. 3, the dispersion angle (in Radians) for a simple prism is shown for different wavelengths. It will be noted that the dispersion of a prism is non-linear. Consequently, although, as illustrated by Newton, a simple prism may be sued to disperse an incident polychromatic light signal into its spectrum, since the output is very far from linear, it is not easy to understand the relative intensities of the different wavelengths using simple detection means such as a charged couple device (CCD) or Complementary metal-oxide-semiconductor (CMOS), for example. Due to this limitation, the simple prism is not ideal for quantitative analysis. On the other hand, diffraction gratings produce secondary and tertiary spectra that may interfere with the primary signal, creating cross-talk, ghosting and other artifacts.

### Compound Prisms

Two prisms A, B with opposite orientation may be combined to form a compound prism, as illustrated in FIG. 4.

An incoming light signal incident on compound prism A,B is diffracted such that the output signal may be projected onto a screen or detector C, which may be a CMOS or CCD or similar.

The total angular deviation may be approximated by:

D=D₁+D₂ [6]

And the total angular dispersion is:

dD=dD₁+dD₂ [7]

To minimize the angular dispersion:

$$dD = \frac{{D}_{1}}{{ν}_{1}} + \frac{{D}_{2}}{{ν}_{2}} = 0 \qquad [ 8 ]$$

By rearranging:

$$\begin{matrix}{D}_{1} = \frac{{Dν}_{1}}{{ν}_{1} - {ν}_{2}} & [ 9 ] \\ and {D}_{2} = \frac{{Dν}_{2}}{{ν}_{2} - {ν}_{1}} & [ 10 ]\end{matrix}$$

And also:

$$\begin{matrix}{θ}_{1} = \frac{{Dν}_{1}}{( {n}_{λ mid , 1} - 1 ) ( {ν}_{1} - {ν}_{2} )} & [ 11 ] \\ and {θ}_{2} = \frac{{Dν}_{2}}{( {n}_{λ mid , 2} - 1 ) ( {ν}_{2} - {ν}_{1} )} & [ 12 ]\end{matrix}$$

Where θᵢ are the apex angles of the prisms, as previously defined.
Secondary angular dispersion

The doublet configuration is limited in that it provides equal angular dispersion for only two wavelengths, namely λₘᵢₙ and λₘₐₓ as can be seen in FIG. 5.

In order to calculate the secondary angular dispersion at wavelength λmid we will use the partial dispersion coefficient:

$$p = \frac{{n}_{λ max} - {n}_{λ mid}}{{n}_{λ max} - {n}_{λ min}} \qquad [ 13 ]$$

To calculate the secondary angular dispersion we substitute v with v/p since

$$\frac{ν}{p} = \frac{{n}_{λ mid} - 1}{{n}_{λ max} - {n}_{λ min}} \text{/} \frac{{n}_{λ max} - {n}_{λ mid}}{{n}_{λ max} - {n}_{λ min}} = \frac{{n}_{λ mid} - 1}{{n}_{λ max} - {n}_{λ mid}} = {ν}_{partial} \qquad [ 14 ]$$

and thus based on [5] and [7], and marking the secondary dispersion as dD3,

$$dD 3 = \frac{{D}_{1} \cdot {p}_{1}}{{ν}_{1}} + \frac{{D}_{2} \cdot {p}_{2}}{{ν}_{2}} \qquad [ 12 ]$$

Substituting D₁ and D₂ from [9] and [10]:

$$\begin{matrix}dD 3 = \frac{D {ν}_{1} {p}_{1}}{{ν}_{1} ( {ν}_{1} - {ν}_{2} )} + \frac{D {ν}_{2} {p}_{2}}{{ν}_{2} ( {ν}_{2} - {ν}_{1} )} = - \frac{{Dp}_{1}}{( {ν}_{2} - {ν}_{1} )} + \frac{{Dp}_{2}}{( {ν}_{2} - {ν}_{1} )} = \frac{D ( {p}_{2} - {p}_{1} )}{( {ν}_{2} - {ν}_{1} )} \\ giving & [ 13 ] \\ dD 3 = \frac{D \cdot Δ p}{Δν} & [ 14 ]\end{matrix}$$

When designing an achromatic doublet dD3 should be minimal, so two glass materials are selected such that Δp would be minimal and Δv would be maximal.

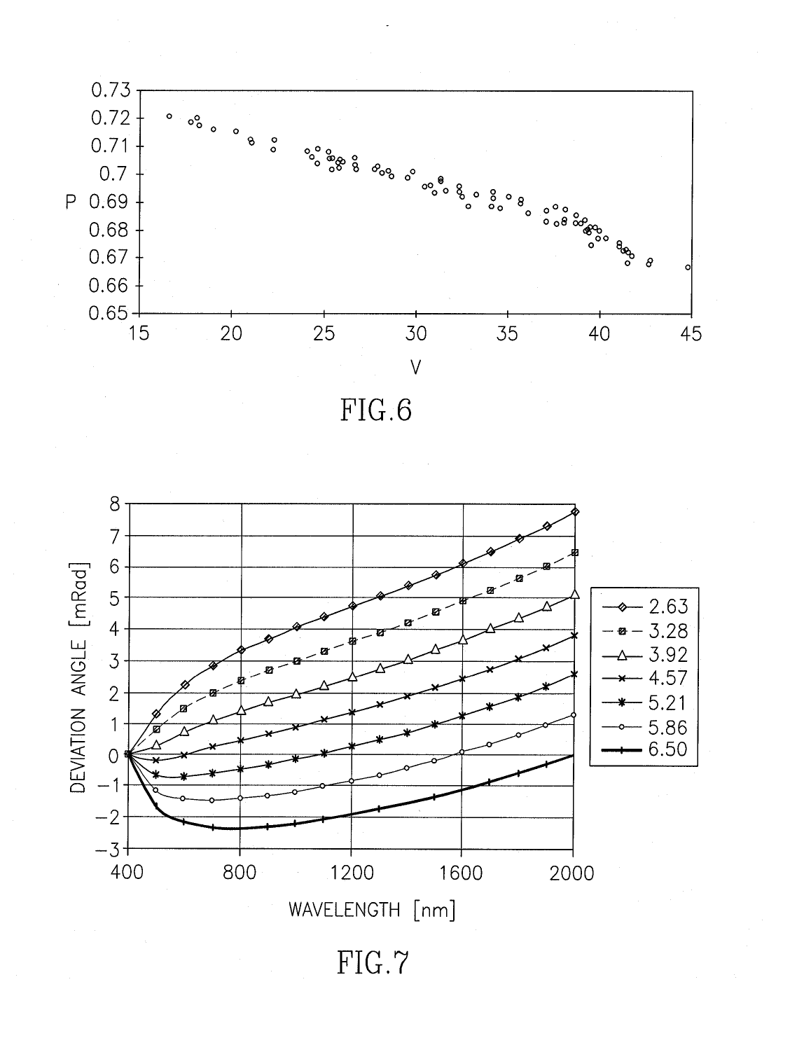

With reference to FIG. 6, a p vs v plot for different glasses is shown, illustrating how different glasses can share common p values. It will be appreciated that the plot depends on the wavelengths chosen to work with. However ready-made plots for the visible region may be found in the literature.

The p-v plot show in FIG. 6 may be used to select pairs of glass materials according to the following guidelines:
For a small Δp the two glass materials should be on the same horizontal line.
For a large Δv the two glass materials should be as far from each other as possible on this horizontal line.
   The choice of optimal glass combinations for a specific purpose is not easy since most glass materials reside close to a line that crosses the plot diagonally. In general, when designing an optical component of the invention, a large ΔP is required.

### Linear Compound Prism

In contradistinction to achromatic prisms, a linear compound prism is designed to have a linearly varying output angle.

Referring back to FIG. 4, a schematic illustration of a compound prism is presented, showing how light is refracted therein. A compound prism consists of two simple prisms in opposite alignment. It has been surprisingly found that by careful choice of the materials used for the two prisms and by careful selection of the apex angle, it is possible to create an optical component that provides a substantially linear dispersion over a surprisingly wide range of wavelengths. It will be appreciated that with the correct choice of glasses and apex angle can provide a substantively linear dispersion, such that the component can be used to analyze optical signals, for various applications such as materials analysis and the like, and for hyper-spectral imaging.

For the compound prism, equations [11] and [12] provide the apex angles of the two glass materials.

FIG. 5 is a Cartesian plot showing how different pairs of glass materials have different secondary angular dispersions and illustrates this idea.

### EXAMPLES

The results may be simulated using Zemax Optical Design Program© Zemax Corp. By changing the apex angle of one of the glass materials it is possible to stray from the achromatic design depicted in FIG. 5. The manner in which this gradually happens may be seen in FIG. 7, which shows the deviation angle with wavelength for a couplet consisting of a BK7 prism with a 20° apex angle, coupled with SF11 prisms having apex angles in the range of 2.63° to 6.5°, illustrating how linear disbursement may be obtained over an appropriate wavelength for an appropriate couplet, It will be noted that when the apex angle of the SF11 prism is 3.92° the angular dispersion is quite linear with relation to the wavelength over a very broad spectral region.

An important observation is that the dispersion from a linear compound prism is smaller than the dispersion of a simple prism. In FIG. 3 it is shown that a 20° BK7 prism gives a dispersion of 8.6 mRad (between 400 and 1000 nm), while a BK7-SF11 pair in its linear form gives only 1.9 mRad—a factor of 22%. These prisms behave similarly for larger apex angles, with dispersion angles growing somewhat faster than linearly.

It should be noted that in order to design a linear compound prism, a large Δp is desired, since the larger the Δp, the more dispersion. This makes it easier to choose the pair of glass materials since we can simply select two glass materials from both ends of the plot in FIG. 6.

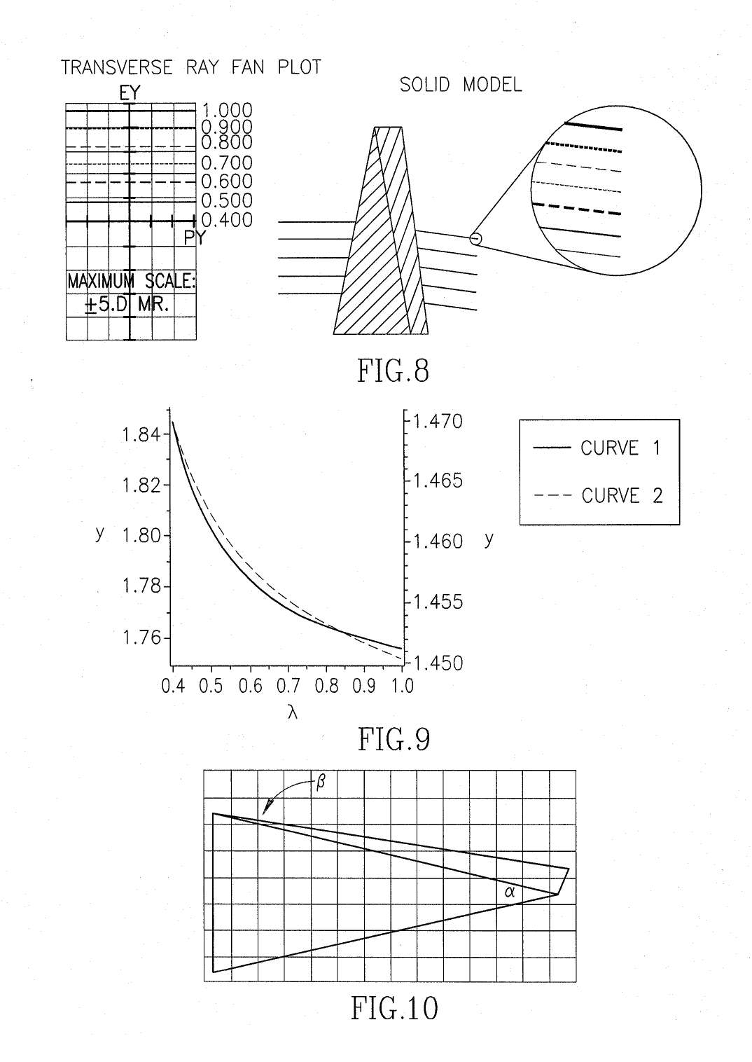

Choosing an irregular combination of materials such as KDP with SF11 gives a very large Δp, and the resulting dispersion of 4.7 mRad may be seen in FIG. 8 (apex angles of 20° and 3.3°).

The double prism may consist of a first prism having an apex angle of 20°. Suitable glasses include BK7 (obtainable from OPG). The optical transmission spectrum of BK7 is given in FIG. 1.

The Specification of BK7 Optical Glass is as follows:

### Optical Properties

Refractive Index nd: 1.51680 (587.6 nm)
Abbe numbers:
ve=63.96
vd=64.17

### Mechanical Properties

Density: 2.51 g/cm3
Young's modulus E: 82×103 N/mm2
Poisson's ratio μ: 0.206
Knoop hardness HK0.1/20: 610

### Thermal Properties

Coefficient of thermal expansion:
7.1×10-6/K (−30° C. to +70° C.)
8.3×10-6/K (+20 to +300° C.)
Viscosities:
Softening Point (107.6 dPa): 719° C.
Annealing Point (1013 dPa): 557° C.
Transformation temperature Tg: 557° C.

### Chemical Resistances

Climate Resistance Class 2
Resistance against humidity is expressed by CR-Classes 1 (high) to 4 (low).
Stain Resistance Class 0
   Resistance against staining is expressed by FR-Classes 0 (high) to 5 (low).
Acid Resistance Class 1
   Resistance against acid solutions is expressed by SR-Classes 0 (high) to 4 (low).
Alkali Resistance Class 2
   Resistance against alkali solutions is expressed by AR-Classes 0 (high) to 4 (low).
Phosphate Resistance Class 2,3
   Resistance against an alkali phosphate solution is expressed by PR-Classes 1 (high) bis 4 (low).

KDP or potassium dihydrogen phosphate (KDP) is birefringment material with the following characteristics:

| | Wavelength | Refractive index | | Transmission |
|---|---|---|---|---|
| Birefringent materials | μm | O-ray | E-ray | range/μm |
| Potassium dihydrogen | 0.546 | 1.5115 | 1.4698 | 0.25 to ~1.7 |
| phosphate . . . (KDP) | 1.014 | 1.4954 | 1.4604 | |

SF11 is a commonly used optical glass.

### Refractive Index

n=1.78471

### Chromatic Dispersion

dn/dλ=−0.153 μm⁻¹

### Abbe Numbers

V_{d}=25.68

Vₑ=25.47

FIG. 8 shows how a KDP prism with a 20° apex angle coupled to an SF11 prism with a 3.3° apex angle provides a linear dispersion.

In general, therefore the linear compound prism satisfies the following equation:

f(λ)=a\sqrt{h(λ)}+b\sqrt{g(λ)}: [15]

Essentially, for a linear compound prism a ratio between a and b is selected such that it is linear in the range of interest.

The rules over a and b are that a is positive and in the range of 1 to 45 and b is always negative in the same range.

The range for λ is given by the physical transparency of the glass.

Proof of Concept

In the following specific solution the Schott definition for refraction index as a function of λ is used. The spectral range is set in accordance with the visible light range i.e. from 0.4 to 1 micron.

Using Schott definition the index of refraction is given by:

$${n}_{schott} \text{:=} sqrt ( \frac{{K}_{1} \cdot {λ}^{2}}{{λ}^{2} - {L}_{1}} + \frac{{K}_{2} \cdot {λ}^{2}}{{λ}^{2} - {L}_{2}} + \frac{{K}_{3} \cdot {λ}^{2}}{{λ}^{2} - {L}_{3}} + 1 ) \text{:} \qquad [ 16 ]$$

To prove the concept that the refraction index of combined prisms of different glasses can be described by linear function, two glasses are used: SF11 and KDP.

The coefficients of SF11 are as follows:

$$\begin{matrix}Kgroup \text{:=} \{ {K}_{1} = 1.73759695 E + 00 , {K}_{2} = 3.13747346 E - 01 , \\ {K}_{3} = 1.89878101 E + 00 , {L}_{1} = 1.31887070 E - 02 , {L}_{2} = 6.23068142 E - 02 , \\ {L}_{3} = 1.55236290 E + 02 \} \text{:}\end{matrix}$$

Assigning the SF11 coefficients into the general function of the refraction index:

SF11:=subs(Kgroup, n_{schott}): [17]

For KPD the coefficients are:

$$\begin{matrix}Kgroup 2 \text{:=} \{ {K}_{1} = 6.70710810 E - 01 , {K}_{2} = 4.33322857 E - 01 , \\ {K}_{3} = 8.77379057 E - 01 , {L}_{1} = 4.49192312 E - 03 , {L}_{2} = 1.32812976 E - 02 , \\ {L}_{3} = 9.58899878 E + 01 \} \text{:}\end{matrix}$$

Following the previous step we apply:

NGlass:=subs(Kgroup2, n_{schott}): [18]

FIG. 9 shows the refraction indexes of SF11 and KPD as a function of λ.

G1:=plot(SF11, λ=0.4 . . . 1, y=1.75 . . . 1.85, color=blue):

G2:=plot(NGlass, λ=0.4 . . . 1, y=1.45 . . . 1.471):

plots [dualaxisplot](G1, G2)

With reference to FIG. 10, a double prism made of different glasses has a refraction index that is a linear combination of the refraction index of each glass. The parameters that rule the final results are the head angle of each prism, giving

n_{new}:=α·n₁+β·n₂: [19]

We have surprisingly found that there is a ratio between α and β that makes the combined refraction index as function of λ essentially linear.

Defining β as function of α and R, the ratio factor

$${β}_{1} \text{:=} - \frac{{α}_{1}}{{R}_{1}} \text{:} \qquad [ 20 ]$$

The specific combination of SF11 and KDP demonstrates that a linear result can be obtained:

SF11inP:=β₁·(SF11−1): [21]

NGlassinP:=α₁·(NGlass−1): [22]

eq1:=SF11inP+NGlassinP: [23]

It will be appreciated that the method and system may be refined by adding further optical components, such as lenses and collimators, for example.

Persons of the art will appreciate that the compound prism may usefully include a third (or more) prism of to increase the linearity or the range of the output. Alternatively, an additional prism may be added in series to the compound prism. Thus persons skilled in the art will appreciate that the present invention is not limited to what has been particularly shown and described hereinabove. Rather the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A method for linear spectral dispersion comprising:
passing an incoming electromagnetic signal through a compound prism comprising two prisms in opposite orientation, where the two prisms are selected to provide a substantially linearly varying output over a broad spectral range.

2. The method of claim 1 further comprising the step of detecting output signals using a detector.

3. The method of claim 1 wherein the detector is selected from the group comprising CCDs and CMOS components.

4. The method of claim 1 comprising providing a further prism to increase the range wherein the output varies in a substantially linearly manner.

5. The method of claim 1 comprising providing a further prism to increase the linearity of the range wherein the output varies in a substantially manner

6. The method of claim 1 wherein Δp is large.

7. The method of claim 1 wherein the compound prism comprises a BK7 or KDP prism with apex angle of 20° coupled to a SF11 prism with apex angle in the range of from 2.5° to 7°.

8. The method of claim 3 wherein the SF11 prism has an apex angle of 3.92°.

9. A system for linear spectral dispersion of an incoming signal, the system comprising a compound prism comprising two prisms of different optical characteristics aligned in opposite rotation.

10. The system of claim 9 further comprising a detector of incident light.

11. The system of claim 10 wherein the detector is selected from the group comprising CMOS and CCD detectors.

12. The system of claim 9 wherein the compound prism comprises a BK7 or KDP prism with apex angle of 20° coupled to a SF11 prism with apex angle in the range of from 2.5° to 7°.

13. The system of claim 9 wherein the SF11 prism has an apex angle of 3.92°.

14. The system of claim 9 further comprising a third prism in series with the compound prism.

15. A spectral imager comprising a compound prism comprising a pair of oppositely arranged simple prisms and a light detector, wherein the oppositely arranged simple prisms are selected such that the compound prism has an output that varies substantially linearly over a range of wavelengths of interest.

16. The spectral imager of claim 15 further comprising a detector selected from the group comprising CMOS and CCD detectors.

17. The spectral imager of claim 15 wherein the compound prism comprises a BK7 or KDP prism with apex angle of 20° coupled to a SF11 prism with apex angle in the range of from 2.5° to 7°.

18. The spectral imager of claim 15 wherein the SF11 prism has an apex angle of 3.92°.

19. The spectral imager of claim 15 further comprising a third prism to increase the linearity of the output over the range of wavelengths of interest.

20. The spectral imager of claim 15 further comprising a third prism to increase the range wherein the output is substantially linear.

21. A method of imaging a spectrum comprising a compound prism designed to produce a linearly varying output over a wide range of wavelengths and a light detector selected from the group comprising CMOS and CCD detectors.

22. The method of imaging a spectrum of claim 21 wherein the compound prism comprises a BK7 or KDP prism with an apex angle of 20° coupled to a SF11 prism with apex angle in the range of from 2.5° to 7°.

23. The method of claim 21 wherein the SF11 prism has an apex angle of 3.92°.
